(19) United States
(12) Patent Application Publication
(10) Pub. No.: US 2018/0149771 A1
(43) Pub. Date: May 31, 2018

(54) OPTICAL MEMBER FORMED FROM SILICON MATERIAL AND OPTICAL DEVICE COMPRISING SAME

(71) Applicant: Carlit Holdings Co., Ltd., Tokyo (JP)

(72) Inventors: Tomohisa Tenma, Gunma (JP); Kazumi Chiba, Gunma (JP); Takumi Ikeda, Nagano (JP)

(21) Appl. No.: 15/569,176

(22) PCT Filed: Mar. 15, 2016
(86) PCT No.: PCT/JP2016/058133

§ 371 Date: Oct. 25, 2017

(30) Foreign Application Priority Data
Apr. 28, 2015 (JP) 2015-091580

(51) Int. Cl. G02B 1/02; C01B 33/02

(52) U.S. Cl. CPC G02B 1/02; C01P 2006/60; C01P 2006/80; C01B 33/02

(57) ABSTRACT

The objective of the present invention is to provide: an optical member which is formed from a silicon material having high infrared transmittance and high hardness; and an optical device which comprises such an optical member. The present invention provides: an optical member for transmitting infrared light, which is formed from a silicon material that has an oxygen concentration of 1.0×10¹⁷ atom/cm³ or less, while containing carbon at a concentration of from 1.0×10¹⁶ atom/cm³ to 8.0×10¹⁸ atom/cm³; and an optical device which comprises this optical member arranged in the optical path of infrared light.

### TECHNICAL FIELD

The present invention relates to an optical member for transmitting infrared light that is formed from a silicon material, and to an optical device incorporating such an optical member.

### BACKGROUND ART

In recent years, the development of devices that employ infrared light has proceeded rapidly. And the development is becoming widespread of optical devices, such as infrared sensors or the like, employing light in the infrared wavelength band of 4 to 15 μm. Moreover, germanium, chalcogenide glass, silicon and so on are known as materials for members that can transmit infrared of wavelength 4 to 15 μm. Among these, silicon is a material that is comparatively cheap and that is convenient for use for an infrared transmission member.

When oxygen is blended into a silicon lens, the infrared transmittance in the vicinity of the wavelength of 9 μm is undesirably reduced. Patent Document #1 discloses a method for manufacturing an optical member that is formed from a solidified polycrystalline silicon body having an oxygen content of 10 ppma or less.

Patent Document #1: JP 2010-163353 A

### SUMMARY OF INVENTION

### Technical Problem

As described in Patent Document #1, for a solidified polycrystalline silicon body in which the amount of included oxygen is 10 ppma or less, the infrared transmittance becomes high. However, investigation by the present inventors has shown that the hardness of a lens made from such a solidified body is low, and that it can easily be chipped. Due to the above, it is an object of the present invention to provide an optical member formed from a silicon material that has high infrared transmittance and moreover whose hardness is high, and to provide an optical device that incorporates such an optical member.

### Solution to Technical Problem

As a result of investigation performed by the present inventors, the present invention has been formulated to have the following contents.

[1] An optical member for transmitting infrared, formed from a silicon material whose oxygen concentration is 1.0×10¹⁷ atom/cm³ or less, and containing carbon at a concentration of from 1.0×10¹⁶ to 8.0×10¹⁸ atom/cm³.

[2] The optical member of [1], wherein said silicon material further contains boron at a concentration of from 1.0×10¹⁴ to 1.0×10¹⁸ atom/cm³.

[3] The optical member of [1] or [2], wherein the transmittance of said silicon material to infrared of wavelength 9 μm is 44% or greater and its Knoop hardness is 1190 kg/mm² or greater.

[4] An optical device, incorporating an optical member according to [1] through [3] that is installed in an infrared optical path.

### Advantageous Effect of Invention

According to the present invention, an optical member is obtained in which high infrared transmittance and high hardness are achieved compatibly. In concrete terms, an optical member is provided that is made from a silicon material, whose infrared transmittance at 9 μm is even higher than before, and that has even higher Kroop hardness.

### DESCRIPTION OF EMBODIMENTS

In the present invention, an “optical member for transmitting infrared” is a member that is adapted to be installed in an optical path for infrared in an optical device or the like but that is not yet so installed, or a member that adapted as described above and that is already so installed. The shape of this optical member is not particularly limited; for example, it could be formed in any of various lenticular shapes, or as a plate.

According to the present invention, this optical member is formed from a silicon material. The silicon material is a silicon material that includes minute amounts of one or more components that will be described hereinafter, and that preferably contains at least 95% by mass of silicon, more preferably contains at least 99% by mass of silicon, and even more preferably consists entirely of silicon except for carbon, oxygen, and optionally boron in amounts that will be described hereinafter. The form of the silicon material is not particularly limited; it could be a single crystal, or could be polycrystalline.

It is desirable for as little oxygen as possible to be included in the silicon material, and preferably the oxygen concentration should be 1.0×10¹⁷ atom/cm³ or less. The lower the oxygen concentration is, the better; and it is particularly desirable that the oxygen concentration should be at or below the limit of detection by the measurement method that will be described hereinafter. As a means for reduction of the oxygen concentration, for example, the use of sapphire, carbon, or boron nitride as the crucible material may be suggested.

This silicon material contains a certain amount of carbon. In concrete terms, the silicon material contains carbon at a concentration of from 1.0×10¹⁶ atom/cm³ to 8.0×10¹⁸ atom/cm³. Adjustment of the carbon concentration may be performed, for example, by mixing together predetermined amounts of silicon raw material and carbon powder, then melting them and mixing them together by application of heat, and then crystallizing the mixture; or by using a melting pot made from carbon as a crucible material for melting the silicon raw material therein, and then crystallizing it. It should be understood that the amount of carbon powder added is not necessarily directly reflected in the carbon concentration in the silicon material, since there is a possibility etc. that a carbon component may be introduced from a jig or the like that is used during the manufacture of the silicon material. Even in that case it is adequately possible, by several iterations of trial and error, to estimate the amount of carbon powder that must be added in order to implement the desired carbon concentration.

By ensuring that the carbon concentration in the silicon material is in the range described above and that the oxygen concentration is small, it is possible to anticipate that both hardness and also infrared transmittance can be achieved in a compatible manner.

The content of oxygen and the content of carbon in the silicon material can be measured by secondary ion mass spectrometry (hereinafter abbreviated as an “SIMS method”). An SIMS method is a surface measurement method in which a beam of ions (primary ions) is irradiated upon the surface of a solid body, and ions (secondary ions) that are generated by collisions on the atomic level between these primary ions and molecules on the surface of the solid body are detected by a mass spectrometer. With an SIMS method, the lower limit for detection of oxygen concentration is approximately 5.0×10¹⁵ atom/cm³.

Preferably, the infrared transmittance at the wavelength of 9 μm is further enhanced by further including boron in the silicon material, and moreover in that case the Knoop hardness is further improved. The concentration of boron included in the silicon material is preferably from 1.0×10¹⁴ atom/cm³ to 1.0×10¹⁸ atom/cm³, more preferably is from 1.0×10¹⁴ atom/cm³ to 5.0×10¹⁷ atom/cm³, and even more preferably is from 1.0×10¹⁴ atom/cm³ to 1.0×10¹⁷ atom/cm³. By keeping the boron concentration within these ranges, it is particularly possible to provide, in a compatible manner and at high levels, both the beneficial effect of enhancement of the infrared transmittance of the silicon member at the wavelength of 9 μm, and also the beneficial effect of enhancing the Knoop hardness.

With regard to the method for adding boron, it would be acceptable to add the boron powder directly, or, alternatively, first to prepare a silicon single crystal containing boron by using boron powder, and then to manufacture the silicon material by using this boron-containing silicon single crystal that has thus been obtained. This method of preparing a boron-containing silicon single crystal in advance will be explained in more concrete terms in the concrete examples that will be described hereinafter. The amount of added boron can be adjusted more simply and easily by manufacturing a boron-containing silicon single crystal in advance in this manner.

The amount of boron that is included in the silicon material may be measured by using the secondary ion mass spectrometry method (i.e. the SIMS method) described above. It should be understood that it would also be acceptable to measure the boron content by using a glow discharge mass spectrometry method. A glow discharge mass spectrometry method is a technique of generating a glow discharge by using a test specimen as a cathode in an argon atmosphere, spattering the surface of the test specimen in plasma, and measuring the ionized constituent elements with a mass spectrometer.

The method for manufacturing the silicon material for obtaining an optical member of a desired shape is not particularly limited; prior art technology related to methods for processing silicon material may be referred to as appropriate. For example, it is possible to obtain an optical member of a desired shape by producing a silicon ingot by the CZ process (i.e. the Czochralski process), by the FZ process (i.e. the floating zone process), by an extrusion molding method, by a mold shaping process, or the like, and by cutting or shaving the silicon ingot that has been obtained as appropriate. When obtaining this silicon ingot, it is desirable to melt polycrystalline silicon as the raw material, and at this time it is possible to adjust the carbon concentration of the silicon material that is obtained by permitting some carbon content appropriately in consideration of the concentration ranges described above. Moreover, it is possible to keep the oxygen concentration extremely small by using sapphire, carbon, boron nitride or the like as the material for the crucible.

Among the above, production by the CZ method is particularly preferable. The CZ method is widely developed as a manufacturing method for obtaining silicon ingots, and may be generally classified as a so-called pulling up method in which a seed crystal is immersed in a silicon raw material melted in a crucible and then is pulled up. When preparing this melted silicon raw material, it is desirable to add a predetermined amount of carbon raw material (carbon powder or the like) to the silicon raw material as described above, and to melt them together. Preferably, a seed crystal is dipped into the silicon raw material that has been melted into a state in which the carbon raw material coexists therewith, and, due to this seed crystal being pulled up while being rotated, a single crystal can be grown in the shape of a circular cylinder that is hanging down from the seed crystal, so that a silicon ingot can be obtained.

The silicon material that has been obtained in this manner can be processed into any desired shape for use as an optical member. The silicon material from which the optical member of the present invention is formed is excellent for transmission of infrared, and desirably its transmittance for infrared of wavelength 9 μm is 44% or greater. The transparency can be measured by using a Fourier transform infrared spectrometer (i.e. a FT-IR device).

The silicon material from which the optical member of the present invention is formed has high hardness, and its Knoop hardness is desirably 1170 kg/mm² or greater, more desirably is 1180 kg/mm² or greater, yet more desirably is 1190 kg/mm² or greater, and most desirably is 1200 kg/mm² or greater. The measurement of Knoop hardness may be performed by using a micro Knoop hardness tester, a micro hardness tester, or the like. Knoop hardness can be calculated from the depth of the indentation that is formed by pressing against a sample that is shaped as a thin sheet or as a plate with a four cornered pyramidal diamond, using a certain force.

The shape of the optical member of the present invention is not particularly limited; for example, it may be shaped as a lens of some type, or as a plate. If the optical member is shaped as a lens, this lens may be used just as it is, or its front surface may be polished. Polishing can form such a glass lens more precisely.

A reflection prevention coating (i.e. an AR coating) may be provided on the surface of the glass lens. It is possible to prevent the reflection of light and to provide even better transmittance by providing such a reflection prevention coating.

The plate shaped optical member may, for example, be used for applications such as a lens material for a far infrared camera, a window material for a far infrared sensor, or the like.

An optical device in which an optical member according to the present invention as described above is installed in the optical path of infrared light is also an embodiment of the present invention. Such optical instruments include, but are not limited to, far infrared cameras and devices for infrared thermography.

### EXAMPLES

The present invention will now be explained in further detail by citing the concrete examples described below. However, the present invention should not be considered as being limited to these concrete examples.

### Examples #1 through #4, and Comparison Examples #1 through #3

In a vacuum, and in a high purity boron nitride crucible (inner diameter ϕ170 mm), a predetermined amount to be described hereinafter of carbon powder was added to 2000 g of polycrystalline silicon in the form of chunks, and this was melted at a temperature of 1550° C. to obtain molten silicon. The molten silicon thus obtained was brought to 1400° C., and was seeded by bringing a silicon seed crystal into contact therewith. Then, first, the silicon seed crystal was pulled up at a pulling-up speed of 1.5 mm/min and at a rotational speed of 2 rpm, whereby a silicon crystal having the same thickness as the silicon seed crystal was grown from the silicon melt to a length of about 40 mm. And subsequently a silicon crystal (diameter ϕ70 mm by 100 mm) was grown at a rotational speed of 20 rpm and at a pulling up speed of 1.0 mm/min. An ingot of crystalline silicon was obtained in this manner.

The amounts of carbon powder that were added during the process described above were as follows:

Example #1: 0.2×10⁻² g

Example #2: 1.4×10⁻² g

Example #3: 2.4×10⁻² g

Example #4: 3.0×10⁻² g

Comparison Example #1: 0.5×10⁻³ g

Comparison Example #2: 3.4×10⁻² g

Comparison Example #3: 0 (none added)

### Examples #5 through #7

In a vacuum, and in a high purity boron nitride crucible (inner diameter ϕ170 mm), 0.149 g of boron was added to 2000 g of polycrystalline silicon in the form of chunks, and this was melted at a temperature of 1550° C. to obtain molten silicon. The molten silicon thus obtained was brought to 1400° C., and was seeded by bringing a silicon seed crystal into contact therewith. Then, first, the silicon seed crystal was pulled up at a pulling-up speed of 1.5 mm/min and at a rotational speed of 2 rpm, whereby a silicon crystal having the same thickness as the silicon seed crystal was grown from the silicon melt to a length of about 40 mm. And subsequently a silicon crystal (diameter ϕ70 mm by 100 mm) was grown at a rotational speed of 20 rpm and at a pulling up speed of 1.0 mm/min. An ingot of crystalline silicon was obtained in this manner. A sample wafer was cut out with a wire saw from the ingot thus obtained, and, when the boron concentration in the surface of this wafer was measured with a glow discharge mass spectrometer (VG-9000, manufactured by VG Elemental Co.), it was found to be 100 ppm. In this manner, a single silicon crystal was obtained which contained boron at 100 ppm.

Separately from the above, in a vacuum, and in a high purity boron nitride crucible (inner diameter ϕ170 mm), 2.4×10⁻² g of carbon powder was added to 2000 g of polycrystalline silicon in the form of chunks, a predetermined amount to be described hereinafter of the single crystal silicon containing boron (at 100 ppm) obtained as described above was further added, and the resulting mixture was melted at a temperature of 1550° C. to obtain molten silicon. The molten silicon thus obtained was brought to 1400° C., and was seeded by bringing a silicon seed crystal into contact therewith. Then, first, the silicon seed crystal was pulled up at a pulling-up speed of 1.5 mm/min and at a rotational speed of 2 rpm, whereby a silicon crystal having the same thickness as the silicon seed crystal was grown from the silicon melt to a length of about 40 mm. And subsequently a silicon crystal (diameter ϕ70 mm by 100 mm) was grown at a rotational speed of 20 rpm and at a pulling up speed of 1.0 mm/min. An ingot of crystalline silicon was obtained in this manner.

The amounts of single crystal silicon containing boron (at 100 ppm) that were added during the process described above were as follows:

Example #5: 6.1×10⁻² g

Example #6: 1.8×10⁻¹ g

Example #6: 6.1 g

### Comparison Example #4

In a vacuum, and in a quartz crucible (inner diameter ϕ170 mm), 2.4×10⁻² g of carbon powder was added to 2000 g of polycrystalline silicon in the form of chunks, and this was melted at a temperature of 1550° C. to obtain molten silicon. The molten silicon thus obtained was brought to 1400° C., and was seeded by bringing a silicon seed crystal into contact therewith. Then, first, the silicon seed crystal was pulled up at a pulling-up speed of 1.5 mm/min and at a rotational speed of 2 rpm, whereby a silicon crystal having the same thickness as the silicon seed crystal was grown from the silicon melt to a length of about 40 mm. And subsequently a silicon crystal (diameter ϕ70 mm by 100 mm) was grown at a rotational speed of 20 rpm and at a pulling up speed of 1.0 mm/min. An ingot of crystalline silicon was obtained in this manner.

### Measurement of the Oxygen Concentration and of the Carbon Concentration

Sample wafers were cut out with a wire saw from the ingots of each example and each comparison example, and the oxygen concentration, the carbon concentration, and the boron concentration at the surface of each of the wafers was measured with a SIMS (made by CAMECA Co.).

### Measurement of the Knoop Hardness

The Knoop hardness at 25° C. and 50% humidity was measured using a micro hardness tester (MXT50, made by Matsuzawa Seiki. Co.). In concrete terms, sample wafers were cut out with a wire saw from the ingots of each example and each comparison example, an indenter was pressed for 15 seconds against the surface of each sample wafer at a loading of 100 gm, the length of the indentation was measured along a diagonal line, and the Knoop hardness was calculated on the basis of that length.

### Measurement of the Transmittance

Sample wafers were cut out with a wire saw from the ingots of each example and each comparison example, their surfaces were polished using a FT-IR device so that the arithmetic mean roughness Ra was 1 nm or less and the thickness became 1 mm, and the centers of the wafers were measured at wavelength 9 μm by using a FT-IR (Fourier transform infrared absorption) method.

The results of measurement were as follows. Here:

C1 is the oxygen concentration (10¹⁶ atom/cm³);

C2 is the carbon concentration (10¹⁶ atom/cm³);

C3 is the boron concentration (10¹⁴ atom/cm³);

N is the Knoop hardness (kg/mm²); and

T is the transmittance (%).

| | C1 | C2 | C3 | N | T |
|---|---|---|---|---|---|
| Example #1 | 5 | 2 | 0 | 1192 | 45 |
| Example #2 | 7 | 20 | 0 | 1195 | 45 |
| Example #3 | 5 | 300 | 0 | 1202 | 45 |
| Example #4 | 5 | 800 | 0 | 1220 | 45 |
| Example #5 | 5 | 300 | 1.6 | 1231 | 47 |
| Example #6 | 7 | 310 | 3.8 | 1234 | 48 |
| Example #7 | 5 | 300 | 160 | 1231 | 47 |
| Comparison Example #1 | 7 | 0.8 | 0 | 1150 | 43 |
| Comparison Example #2 | 5 | 1000 | 0 | 1218 | 41 |
| Comparison Example #3 | 5 | 0 | 0 | 1118 | 43 |
| Comparison Example #4 | 100 | 20 | 0 | 1160 | 34 |

As described above, with the examples, it is possible to obtain silicon wafers that are compatible both with high transmittance and also with high Knoop hardness. When this type of wafer has been obtained, a person skilled in the art is able, using this wafer, to manufacture an optical member such as a lens or a window or the like of excellent quality by processing methods of various types, such as for example by an extrusion method or a grinding method or the like, and also is able to manufacture an optical device in which an optical member of this type is installed.

Embodiments illustrative of the present invention have been explained above in detail. However, it would be possible to make various modifications and additions to the present invention, without deviating from its spirit or scope. Accordingly the above description is only given in order to furnish illustrative examples, and is not provided in order to limit the range of the present invention.

1. An optical member for transmitting infrared, formed from a silicon material whose oxygen concentration is 1.0×10¹⁷ atom/cm³ or less, and containing carbon at a concentration of from 1.0×10¹⁶ to 8.0×10¹⁸ atom/cm³

2. The optical member described in claim 1, wherein said silicon material further contains boron at a concentration of from 1.0×10¹⁴ to 1.0×10¹⁸ atom/cm³.

3. The optical member described in claim 1, wherein the transmittance of said silicon material to infrared of wavelength 9 μm is 44% or greater and its Knoop hardness is 1190 kg/mm² or greater.

4. The optical member described in claim 2, wherein the transmittance of said silicon material to infrared of wavelength 9 μm is 44% or greater and its Knoop hardness is 1190 kg/mm² or greater.

5. An optical device, comprising an optical member as described in claim 1 that is installed in an infrared optical path.

6. The optical device described in claim 5, wherein said silicon material further contains boron at a concentration of from 1.0×10¹⁴ to 1.0×10¹⁸ atom/cm³.

7. The optical device described in claim 5, wherein the transmittance of said silicon material to infrared of wavelength 9 μm is 44% or greater and its Knoop hardness is 1190 kg/mm² or greater.

8. The optical device described in claim 6, wherein the transmittance of said silicon material to infrared of wavelength 9 μm is 44% or greater and its Knoop hardness is 1190 kg/mm² or greater.
